(19) United States
(12) Patent Application Publication
(10) Pub. No.: US 2014/0044852 A1
(43) Pub. Date: Feb. 13, 2014

(54) SWEETENER CRYSTALS AND METHOD OF MAKING

(71) Applicant: McNeil Nutritionals, LLC, Fort Washington, PA (US)

(72) Inventors: Shyhyuan Liao, West Windsor, NJ (US); Joseph R. Panarisi, JR., Perrineville, NJ (US)

(73) Assignee: McNeil Nutritionals, LLC., Fort Washington, PA (US)

(21) Appl. No.: 13/957,724

(22) Filed: Aug. 2, 2013

Related U.S. Application Data
(60) Provisional application No. 61/682,456, filed on Aug. 13, 2012.

(51) Int. Cl. A23L 1/236

(52) U.S. Cl. CPC A23L 1/2363
USPC 426/548; 426/658

(57) ABSTRACT

A sweetening composition comprising a crystalline matrix wherein the crystalline matrix comprises a high intensity sweetener and a carrier/substrate, and wherein the composition has a bulk density of about 0.4 g/cc to about 1.0 g/cc.

This application claims priority of the benefits of the filing of U.S. Provisional Application Ser. No. 61/682,456, filed Aug. 31, 2012, the contents of each of which are hereby incorporated by reference in their entirety.

### BACKGROUND OF THE INVENTION

1. Field of the Invention

The present invention relates to sweetening compositions. More particularly, the present invention relates to sweetening compositions comprising a high intensity sweetening compound (e.g., Luo Han Guo) and a carrier/substrate (a monosaccharide, a disaccharide, a sugar alcohol, and combinations thereof). Also, disclosed are methods of making such compositions.

2. Background

Various sugar substitute sweeteners have been formulated for table top use. Often the formulation of the sweetener product tried to hide or overcome the undesirable taste perceptions (e.g., bitterness) inherent in the sweetener product. Consumers want a sweetener product that tastes like sugar and has many of the properties of sugar, without the calories of sugar.

### BRIEF SUMMARY OF THE INVENTION

The present invention is directed to a sweetening composition comprising a crystalline matrix, wherein the crystalline matrix comprises a high intensity sweetener, and a carrier /substrate, and wherein the composition has a bulk density of about 0.4 g/cc to about 1.0 g/cc.

The present invention also is directed to a method of making a sweetening composition comprising the steps of (a) combining a high intensity sweetener, a carrier/substrate, and water, thus forming a mixture or solution; (b) heating the mixture or solution; and (c) cooling the mixture, thereby forming co-crystals.

In one embodiment, the method of making a sweetening composition comprises the steps of (a) combining a high intensity sweetener, a carrier/substrate, and water, thus forming a mixture or solution; (b) mixing the mixture or solution; and (c) cooling the mixture, thereby forming co-crystals.

### DETAILED DESCRIPTION OF THE INVENTION

As used herein, a gram of Sucrose Equivalent Sweetness (“SES”) is understood to mean the amount of low or high intensity sweetener needed to be added to an 8 ounce glass of water in order to provide the same sweetness as an independent 8 ounce glass of water containing one gram of sucrose. For example, 1/300 g of rebaudioside A will equal about one gram of SES because rebaudioside A is about 300 times sweeter than sucrose. Similarly, about 1/50 g of glycyrrhizin will provide one gram of SES because glycyrrhizin is about 50 times sweeter than sucrose. And 1/200 g of Luo Han Guo will equal about one gram of SES because Luo Han Guo is about 200 times sweeter than sucrose.

As used herein a “high intensity sweetener” delivers 50 grams of SES or more per gram of solids.

As used herein a “low intensity sweetener” delivers between 0.2 to 1.5 grams of sucrose-equivalent sweetness (SES) per gram of solids. Low-intensity sweeteners include erythritol, xylitol, maltitol, maltooligosaccharide, mannitol, sorbitol, tagatose, glucose, fructose and sucrose. Since some of these are less sweet than others, the proportions and concentration of these sweeteners will affect the sweetness quality of the composite.

The present invention is directed to a sweetening composition comprising a crystalline matrix, wherein the crystalline matrix comprises a high intensity sweetener and a carrier/substrate, and wherein the composition has a bulk density of about 0.4 g/cc to about 1.0 g/cc.

The sweetening composition has an improved natural flavor quality that may be perceived as a more pleasant sweet taste with reduced off-flavors from undesirable components, or reduced bitter notes.

In addition, the sweetening composition has a more balanced taste profile. The combination of a high intensity sweetener and a carrier/substrate in a co-crystallized matrix has a more balanced sweetness profile because the release of the sweetener is based on the solubility of the entrapment matrix, whereas in a dry blend or topical coating application there is direct and immediate interaction with sweet receptors in the mouth.

### High Intensity Sweetener

An essential component of the sweetening composition is a high intensity sweetener. High intensity sweeteners include, but are not limited to, for example, aspartame, acesulfame, alitame, brazzein, cyclamic acid, dihydrochalcones, extract of Dioscorophyllum cumminsii, extract of the fruit of Pentadiplandra brazzeana, glycyrrhizin (and related structures), hernandulcin, monatin, monellin, mogroside, neotame, neohesperidin, saccharin, sucralose, extracts of sweet plants, such as stevia, luo han guo, agave, Thaumatin katemfe fruit (Thaumatococcus daniellii), Hernandulcin-lippia duclis, and combinations thereof.

In one embodiment, the high intensity sweetening compound is luo han guo. Luo han guo is the fruit obtained from an herbaceous perennial vine, i.e., Siraitia grosvenorii. This fruit is from the Cucurbitaceae family. It is also commonly referred to as monk fruit and is about 5 to 7 cm in diameter. The exterior of the fruit is a yellow-brownish or green-brownish color, with a hard surface covered with fine hairs. Inside it contains a sweet, edible pulp and seeds. The sweet taste is derived mainly from a group of triterpene glycosides that make up approximately 1% of the flesh of the fruit, i.e., mogrosides. The mogrosides are numbered from I to V. Among them, mogrosides V and IV are known to be the sweetening components. The fruit also contains bitter components such as mogroside III and mogroside II E (unripe fruits). Cold weather prevents some fruits from maturing naturally. The unripe fruits have a bitter taste and may be included with ripe fruit during cultivation. Luo Han Guo, is roughly 200 times sweeter than sugar. It also has delayed onset sweetness, and at high levels has an aftertaste.

In another embodiment, stevioside, sometimes referred to as stevia and rebaudioside A are exemplary glycosides of the diterpene derivative steviol, extracted and refined from Stevia rebaudiana bertoni (also known as eupatorium rebaudianum bertoni) leaves. These glycosides are high intensity sweeteners, about 100 to about 500 times that of sucrose, but have metallic and bitter notes. They can be used in a wide range of low or reduced calorie food products and beverages. “Stevia extract” or “extracts of Stevia” refer to a mixture of steviol glycoside extracted from a Stevia plant. Stevia extracts include, for example, such steviol glycosides as rebaudioside A, rebaudioside B, rebaudioside C, rebaudioside D, rebaudioside E, dulcoside A and dulcoside B.

The high intensity sweetening compound is included in the sweetening composition in an amount from about 0.01 wt. % to about 50 wt. %, based on the total weight of the composition. Preferably, the high intensity sweetening compound is about 0.2 wt. % to about 10 wt. %, more preferably, about 1.0 wt. % to about 2.5 wt. %, and even more preferably, about 1.2 wt. % to about 2.3 wt. %, based on the total weight of the composition.

### Carriers

Another essential feature of the inventive composition is the inclusion of a monosaccharide, a disaccharide, a polysaccharide, sugar alcohol, low intensity sweetener or combinations thereof.

Monosaccharides include, for example, glucose, fructose, galactose, xylose, ribose, and combinations thereof.

Disaccharides include, for example, sucrose, lactulose, lactose, maltose, trehalose, cellobiose, kojibiose, nigerose, isomaltose, β,β-trehalose, α,β-trehalose, sophorose, laminaribiose, gentiobiose, turanose, maltulose, palatinose, gentiobiulose, mannobiose, melibiose, melibiulose, rutinose, rutinulose, xylobiose, and combinations thereof.

Polysaccharides include, for example, fructooligosaccharide (FOS) and other fibers, maltooligosaccharides, and the like.

Sugar alcohols are food grade alcohols derived from one or more sugar molecules. Sugar alcohols include, for example, erythritol, glycol, glycerol, threitol, arabitol, xylitol, ribitol, mannitol, sorbitol, dulcitol, iditol, isomalt, maltitol, lactitol, polyglycitol and combinations thereof. Erythritol is especially useful as it can mitigate some of the bitter taste.

The sweetener composition has a ratio of carrier/substrate to high intensity sweetening compound of from about 1:1 to about 99.9:0.1. In one embodiment, the ratio of carrier material to high intensity sweetening compound of from about 10:1 to about 90:1. In another embodiment, the ratio of carrier material to high intensity sweetening compound of from about 25:1 to about 50:1. In yet another embodiment, the ratio of carrier material to high intensity sweetening compound of from about 30:1 to about 40:1.

Additionally, a variety of ingredients may be included in the sweetening composition of the present invention.

For example, a bulking agent or other carrier material may be included. The carrier material may be in the form of a simple mixture, or co-crystallized with the high intensity sweetener.

Fruit extracts may be added to contribute additional flavor or color attributes that can elicit the perception of “natural” in the sweetener. Strawberry or blueberry flavored syrups or other berry syrup solids, as well as various concentrated fruit juices comprise a number of sweet and non-sweet compounds that contribute to the perception of “natural.”

Another optional ingredient in the composition of the present invention is a soluble food ingredient. The soluble food ingredient may be, for example, a fructooligosaccharide (FOS), a digestion resistant maltodextrin (e.g., FiberSol), erythritol, inulin, a sugar polymer, or any combination thereof. Preferably, the soluble food ingredient is a fiber.

Vitamins and minerals may also be present.

The compositions may contain other components, including flavor, aroma, other nutritional component, binders, and mixtures thereof.

The sweetening compositions disclosed, can be amorphous or crystalline solids.

Preferably the sweetening compositions have less than 2.5 kcals per teaspoon (equal in sweetness to 1 tsp of sucrose), but can be formulated to deliver a wide variety of caloric contents less than the 4 kcals per gram of SES (the caloric value of sucrose). For example, the compositions can be formulated using techniques known to those working in the area, such as low bulk density spray drying, to any practical density.

The sweetening composition may be formulated to be a zero calorie or low calorie product. In one embodiment, the sweetener composition may be formulated to have less than 2 kcal per gram of SES. In another embodiment, the sweetening composition has less than 1 kcal per gram of SES. In yet another embodiment, the sweetening composition has less than 0.5 kcal per gram of SES. In still yet another embodiment, the sweetening composition has less than 0.25 kcal per gram of SES.

Additionally, the sweetener composition has a density of from about 0.4 g/cm³ to about 1.0 g/cm³. Preferably, from about 0.5 g/cm³ to about 0.85 g/cm³.

The sweetener composition has a ratio of carrier material to high intensity sweetening compound of from about 1:1 to about 99:1. In one embodiment, the ratio of carrier material to high intensity sweetening compound of from about 10:1 to about 90:1. In another embodiment, the ratio of carrier material to high intensity sweetening compound of from about 25:1 to about 50:1. In yet another embodiment, the ratio of carrier material to high intensity sweetening compound of from about 30:1 to about 40:1.

The inventive sweetening composition may be made by any suitable process. An important feature of any of the methods of manufacturing is that the crystalline matrix is formed by co-crystallizing the high intensity sweetener with the carrier/substrate.

In one embodiment, the high intensity sweetening compound and carrier/substrate are blended in water. The solution is heated to a temperature sufficient to completely dissolve all components (e.g., 90° C.). Afterwards, the solution is cooled to room temperature while continuing to stir. The cooled product is spread out to form a thin layer and allowed to dry at room temperature. Crystals are formed and collected.

In one embodiment, the high intensity sweetener, carrier/substrate and water are heated to a temperature of about 40° C. to about 110° C. More preferably, the high intensity sweetener, carrier/substrate and water are heated to a temperature of about 60° C. to about 100° C. In a particular embodiment, the high intensity sweetener, carrier/substrate and water are heated to a temperature of about 90° C.

In one embodiment, a sweetening composition is made by (a) combining a high intensity sweetener, a carrier/substrate, and water, thus forming a mixture or solution; (b) mixing the mixture or solution; and (c) cooling the mixture, thereby forming co-crystals.

Optionally, the method may include a drying step in combination with or after the cooling step. Or, the method may include a resting step in combination with or after the cooling step. Or, the method may include a drying and a resting step in combination with or after the cooling step.

It is desirable to have a uniform table-top sweetener, where the sweetener has the crystalline appearance of sugar.

The sweetening composition may be packaged in any format known to those skilled in the art. For example, sachets, bulk bags, packets, bags, canisters, tubs, bottles, jars, drums, etc. may be used for packaging.

### Characteristics/Properties

The inventive sweetening composition desirably has a sugar like appearance, which may be modified to achieve specific appearance characteristics. In one embodiment, the inventive composition has white crystals with a sparkling sheen to resemble table sugar. In another embodiment, the sweetening composition may have a color ranging from light brown be dark brown to resemble brown sugar.

The inventive composition is suitably designed to be a 1:1 volume replacement for sugar. That is the inventive composition is a cup for cup replacement of sugar.

Typically, the composition has a particle size from about 250 microns to about 2000 microns. Preferably, the composition has a particle size from about 300 microns to about 850 microns.

Additionally, the sweetening composition has a natural taste and/or improved stability.

Unless otherwise defined, all technical and scientific terms used herein have the same meaning as commonly understood by one of ordinary skill in the art to which this invention pertains. The materials, methods, and examples described herein are illustrative only and not intended to be limiting.

The following example is provided to further illustrate the compositions and methods of the present invention. The example is illustrative only and is not intended to limit the scope of the invention in any way.

### EXAMPLES

### Erythritol and Sucralose Co-Crystallization

1. Procedure

### 1.1 Example 1

1.1.1 Dissolve 375 g erythritol and 5 g sucralose into 125 g water. Heat solution until it reaches to 90° C. on a stir plate and completely dissolved.

1.1.2 Place the solution in a different stir plate, and cool down to room temperature with stirring.

1.1.3 Spread the cooled product on a parchment paper in a very thin layer, and dry overnight at room temperature.

1.1.4 Collect and weigh crystals, and test moisture and sucralose content.

### 1.2 Example 2

1.2.1 Procedure similar to 1.1, except using 372.5 g erythritol and 7.5 g sucralose.

### 1.3 Example 3

1.3.1 Procedure similar to 1.1, except using 370 g erythritol and 10 g sucralose.

### 1.4 Example 4

1.4.1 Dissolve 298 g erythritol and 5 g sucralose into 202 g water. Heat solution until it reaches to 90° C. on a stir plate and completely dissolved.

1.4.2 Place the solution in a different stir plate, and cool down to room temperature with stirring.

1.4.3 When the solution reaches ˜25° C., filter it using paper filter #417.

1.4.4 Weigh the mother liquor and test °Brix and sucralose content.

1.4.5 Spread the crystals on a parchment paper in a very thin layer, and dry overnight at room temperature.

1.4.6 Collect and weigh crystals, and test moisture and sucralose content.

TABLE 1
Erythritol and Sucralose Co-crystallization Trial Results

| Parameters | Example 1 | Example 2 | Example 3 | Example 4 |
|---|---|---|---|---|
| Water, g | 125 | 125 | 125 | 202 |
| Temperature, ° C. | 90 | 90 | 90 | 90 |
| Sucralose, g | 5 | 7.5 | 10 | 5 |
| Erythritol, g | 375 | 372.5 | 370 | 298 |
| Resulting Sucralose, % | 1.53 | 1.83 | 1.90 | 0.46 |
| Particle size | medium | medium | medium | large |
| Stirring, yes or no | yes | yes | yes | yes |
| Filtering, yes or no | no | no | no | yes |

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A sweetening composition comprising:
a crystalline matrix wherein the crystalline matrix comprises a high intensity sweetener and a carrier/substrate, and wherein the composition has a bulk density of about 0.4 g/cc to about 1.0 g/cc.

2. The composition of claim 1, wherein the composition has a bulk density of about 0.5 g/cc to about 0.85 g/cc.

3. The composition of claim 1, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monatin, monellin, mogroside, neotame, neohesperidin, saccharin, sucralose, stevia extracts, luo han guo, agave, Thaumatin katemfe fruit (Thaumatococcus daniellii), Hernandulcin-lippia duclis, and combinations thereof.

4. The composition of claim 1, wherein the high intensity sweetener is luo han guo.

5. The composition of claim 1, wherein the carrier/substrate is selected from the group consisting of a monosaccharide, a disaccharide, a polysaccharide, a sugar alcohol, a low-intensity sweetener and mixtures thereof.

6. The composition of claim 1, wherein the carrier/substrate is glucose, fructose, galactose, xylose, ribose, sucrose, lactulose, lactose, maltose, trehalose, cellobiose, kojibiose, nigerose, isomaltose, β,β-trehalose, α,β-trehalose, sophorose, laminaribiose, gentiobiose, turanose, maltulose, palatinose, gentiobiulose, mannobiose, melibiose, melibiulose, rutinose, rutinulose, xylobiose, erythritol, glycol, glycerol, threitol, arabitol, xylitol, ribitol, mannitol, sorbitol, dulcitol, iditol, isomalt, maltitol, lactitol, polyglycitol, maltodextrin and mixtures thereof.

7. The composition of claim 1, wherein the sweetening composition has less than 0.25 kcal per gram of SES.

8. The composition of claim 1, wherein the sweetening composition has less than 0.5 kcal per gram of SES.

9. The composition of claim 1, wherein the sweetening composition has a ratio of carrier/substrate to high intensity sweetener is from about 1:1 to about 99.9:0.1.

10. The composition of claim 1, wherein the sweetening composition has a ratio of carrier/substrate to high intensity sweetener is from about 10:1 to about 90:1.

11. The composition of claim 1, wherein the sweetening composition has a ratio of carrier/substrate to high intensity sweetener is from about 25:1 to about 50:1.

12. The composition of claim 1, wherein the sweetening composition has a ratio of carrier/substrate to high intensity sweetener is from about 30:1 to about 40:1.

13. The composition of claim 1, wherein the composition has a particle size from about 250 microns to about 2000 microns.

14. The composition of claim 1, wherein the composition has a particle size from about 300 microns to about 850 microns.

15. The composition of claim 1, wherein the resulting sweetening composition has a white color with a sparkling sheen.

16. The composition of claim 1, wherein the resulting sweetening composition has a color ranging from light brown to dark brown.

17. The composition of claim 1, wherein the resulting sweetening composition has a natural taste.

18. The composition of claim 1, wherein the resulting sweetening composition has an improved stability.

19. The composition of claim 1, wherein the resulting sweetening composition is a 1:1 volume replacement for sugar.

20. A method of making a sweetening composition comprising the steps of:
(a) combining a high intensity sweetener, a carrier/substrate, and water, thus forming a mixture or solution;
(b) heating the mixture or solution; and
(c) cooling the mixture, thereby forming co-crystals.

21. The method of claim 20, further comprising a drying step in combination with or after the cooling step.

22. The method of claim 20, further comprising a resting step in combination with or after the cooling step.

23. The method of claim 20, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monatin, monellin, mogroside, neotame, neohesperidin, saccharin, sucralose, stevia extracts, luo han guo, agave, Thaumatin katemfe fruit (Thaumatococcus daniellii), Hernandulcin-lippia duclis, and combinations thereof.

24. The method of claim 20, wherein the carrier/substrate is selected from the group consisting of a monosaccharide, a disaccharide, a polysaccharide, a sugar alcohol, a low-intensity sweetener and mixtures thereof.

25. The method of claim 20, wherein the carrier/substrate is glucose, fructose, galactose, xylose, ribose, sucrose, lactulose, lactose, maltose, trehalose, cellobiose, kojibiose, nigerose, isomaltose, β,β-trehalose, α,β-trehalose, sophorose, laminaribiose, gentiobiose, turanose, maltulose, palatinose, gentiobiulose, mannobiose, melibiose, melibiulose, rutinose, rutinulose, xylobiose, erythritol, glycol, glycerol, threitol, arabitol, xylitol, ribitol, mannitol, sorbitol, dulcitol, iditol, isomalt, maltitol, lactitol, polyglycitol, maltodextrin and mixtures thereof.

26. The method of claim 20, wherein the high intensity sweetener, carrier/substrate is heated to a temperature of about 40° C. to about 110° C.

27. The method of claim 20, wherein the high intensity sweetener, carrier/substrate is heated to a temperature of about 60° C. to about 100° C.

28. The method of claim 20, wherein the high intensity sweetener, carrier/substrate is heated to a temperature of about 90° C.

29. A method of making a sweetening composition comprising the steps of:
(a) combining a high intensity sweetener, a carrier/substrate, and water, thus forming a mixture or solution;
(b) mixing the mixture or solution; and
(c) cooling the mixture, thereby forming co-crystals.

30. The method of claim 29, further comprising a drying step in combination with or after the cooling step.

31. The method of claim 29, further comprising a resting step in combination with or after the cooling step.

32. The method of claim 29, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monatin, monellin, mogroside, neotame, neohesperidin, saccharin, sucralose, stevia extracts, luo han guo, agave, Thaumatin katemfe fruit (Thaumatococcus daniellii), Hernandulcin-lippia duclis, and combinations thereof.

33. The method of claim 29, wherein the carrier/substrate is selected from the group consisting of a monosaccharide, a disaccharide, a polysaccharide, a sugar alcohol, a low-intensity sweetener and mixtures thereof.

34. The method of claim 29, wherein the carrier/substrate is glucose, fructose, galactose, xylose, ribose, sucrose, lactulose, lactose, maltose, trehalose, cellobiose, kojibiose, nigerose, isomaltose, β,β-trehalose, α,β-trehalose, sophorose, laminaribiose, gentiobiose, turanose, maltulose, palatinose, gentiobiulose, mannobiose, melibiose, melibiulose, rutinose, rutinulose, xylobiose, erythritol, glycol, glycerol, threitol, arabitol, xylitol, ribitol, mannitol, sorbitol, dulcitol, iditol, isomalt, maltitol, lactitol, polyglycitol, maltodextrin and mixtures thereof.

35. The method of claim 29, wherein the high intensity sweetener, carrier/substrate and water are heated to a temperature of about 40° C. to about 110° C.

36. The method of claim 29, wherein the high intensity sweetener, carrier/substrate and water are heated to a temperature of about 60° C. to about 100° C.

37. The method of claim 29, wherein the high intensity sweetener, carrier/substrate and water are heated to a temperature of about 90° C.
